(19) United States
(12) Patent Application Publication
(10) Pub. No.: US 2015/0261662 A1
(43) Pub. Date: Sep. 17, 2015

(54) ADDRESS-PARTITIONED MULTI-CLASS PHYSICAL MEMORY SYSTEM

(71) Applicant: ADVANCED MICRO DEVICES, INC., SUNNYVALE, CA (US)

(72) Inventors: Gabriel H. LOH, Bellevue, WA (US); Nuwan S. JAYASENA, Sunnyvale, CA (US); Michael IGNATOWSKI, Austin, TX (US)

(73) Assignee: ADVANCED MICRO DEVICES, INC., SUNNYVALE, CA (US)

(21) Appl. No.: 14/206,512

(22) Filed: Mar. 12, 2014

(51) Int. Cl. G06F 12/02

(52) U.S. Cl. CPC G06F 12/023; G06F 12/0284; G06F 2212/1044

(57) ABSTRACT

A multilevel memory system includes a plurality of memories and a processor having a memory controller. The memory controller classifies each memory in accordance with a plurality of memory classes based on its level, its type, or both. The memory controller partitions a unified memory address space into contiguous address blocks and allocates the address blocks among the memory classes. In some implementations, the memory controller then can partition the address blocks assigned to each given memory class into address subblocks and interleave the address subblocks among the memories of the memory class.

### GOVERNMENT LICENSE RIGHTS

This invention was made with government support under Prime Contract Number DE-AC52-07NA27344, Subcontract Number B600716 awarded by the Department of Energy (DOE). The Government has certain rights in this invention.

### BACKGROUND

1. Field of the Disclosure

The present disclosure relates generally to memory systems, and more particularly to memory systems employing multiple memories.

2. Description of the Related Art

Processing systems may implement multiple types or levels of memory (e.g. combinations of volatile and non-volatile memory architectures or in-package and outside-package memory) to satisfy a variety of design requirements. For example, multilevel memory may be used to take advantage of increased bandwidth, capacity, and expandability by combining memories that offer one or more of these features. Some implementations of multilevel memory use one level of memory as a large cache for a second level of memory, but this approach relies solely on hardware control for effective use of the first level of memory and limits the overall system memory to the size of the second level memory. Typically, conventional memory systems utilizing a single level of memory interleave memory addresses among the different memories of the single level, such that data blocks can be requested concurrently from each of the memories of the single level, and the requested data will return in approximately the same order as requested due to the similar access speeds of the single-level memories. However, applying this same approach to a multilevel memory system requires interleaving memory addresses between multiple separate physical memory address spaces, and can result in lower system performance due to differences in response speeds or other performance characteristics between memories of different levels or of different types.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system employing a multilevel memory system in accordance with some embodiments.

FIG. 2 is a flow diagram illustrating a method for allocating memory address space among memories of a multilevel memory system in accordance with some embodiments.

FIG. 3 is a diagram illustrating an example mapping of unified memory address space for the multilevel memory system of FIG. 1 in accordance with some embodiments.

FIG. 4 is a diagram illustrating an example mapping of unified memory address space for multiple-bank memory in accordance with some embodiments.

FIG. 5 is a block diagram of a system to selectively configure the memory address space mapping of the multilevel memory system of FIG. 1 based on a set of hard-wired mapping options in accordance with some embodiments.

FIG. 6 is a diagram illustrating an operation of a memory controller of the multilevel memory system of FIG. 1 in accordance with some embodiments.

FIG. 7 is a flow diagram illustrating a method for designing and fabricating an integrated circuit device implementing at least a portion of a component of a processing system in accordance with some embodiments.

### DETAILED DESCRIPTION

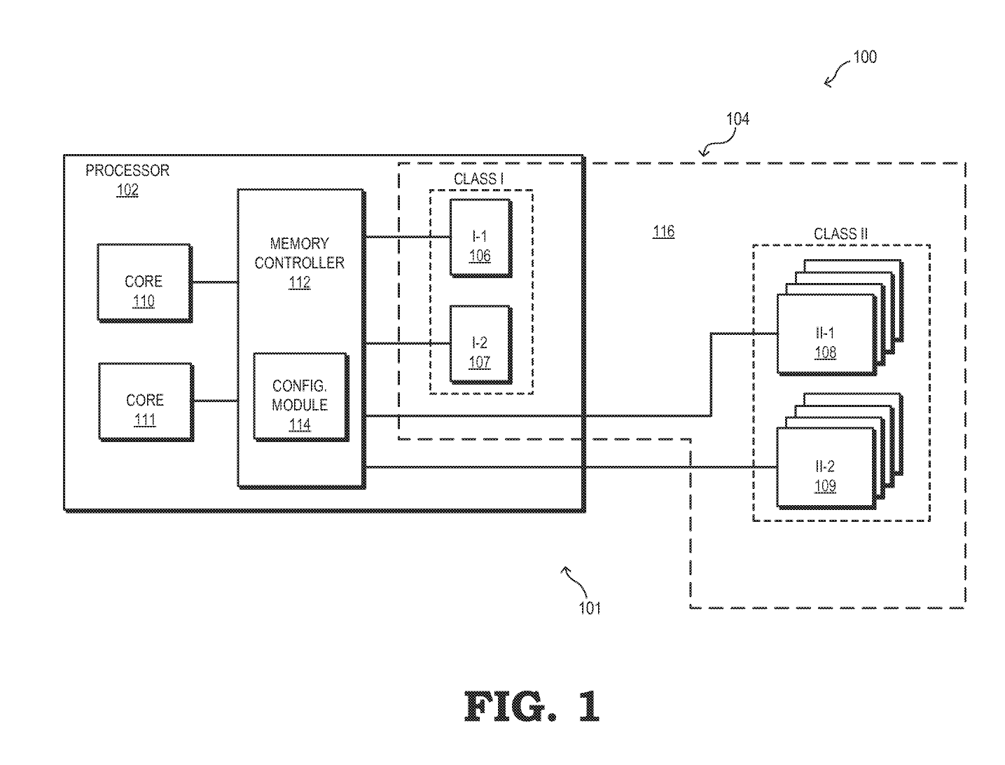

FIGS. 1-7 illustrate example implementations of memory address space allocation in a multilevel memory system. In some embodiments, a memory controller configures a plurality of memories comprising at least two different memory classes as a single, unified, memory address space; that is, one contiguous address space comprising consecutive address values. The memory controller further classifies and groups each memory in accordance with its memory class, such that the memories within a memory class share a common memory type (e.g., memory architecture type), memory level (e.g., memories in the same chip or device package (i.e., “in-package”) vs. memories outside of the same chip or device package (i.e., “outside-package”)), or both. The memory controller segments the unified address space into address blocks and allocates the address blocks among the memory classes. The memory controller then divides each address block allocated to a given memory class into address subblocks and interleaves the address subblocks among the memories assigned to the given memory class. This class-based interleaving technique allows the multilevel memory system to take advantage of the benefits of different classes of memory while still mapping to a single, flat physical memory address space, thereby making the aggregate capacity of the memories completely available to the system, and allowing software to control data allocation among the classes of memory.

While the embodiments described herein depict a multilevel memory system having two classes of memory with two memories in each class for ease of illustration, the techniques discussed herein likewise can be applied to any of a variety of configurations employing three or more classes of memory, as well as differing number of memories within a given class.

FIG. 1 illustrates a block diagram of a processing system 100 employing a multilevel memory system 101 in accordance with some embodiments. The processing system 100 comprises a processor 102 and a memory hierarchy 104 comprising a plurality of memories belonging to two or more different classes, each class defining one or both of a level and a type. The memory level is based on the locational access speed of the memory. For example, between in-package memory and outside-package memory (or “on-chip” and “off-chip” memories), the access speed of the in-package memory will generally be faster. The memory type is based on the particular architecture of the memory, and each memory may comprise any of a variety of memory types, for example, lower granularity divisions, such as volatile memory vs. non-volatile memory or dynamic random access memory (DRAM) vs. static random access memory (SRAM) vs. phase change memory vs. memristor memory, or higher granularity divisions, such as different architectures within the same type of general memory architecture, such as double data rate type three synchronous dynamic random access memory (DDR3 SDRAM), graphics double data rate version five synchronous dynamic random access memory (GDDR5 SDRAM), and low power double data rate synchronous dynamic random access memory (LPDDR SDRAM). Further, while the memory hierarchy 104 is illustrated in the embodiment of FIG. 1 as two in-package memories 106, 107 and two outside-package memories 108, 109, other embodiments may employ any number of memories spanning at least two classes. Additionally, in some embodiments the memory hierarchy 104 may comprise any combination of in-package and outside-package memories, including all outside-package memory and all in-package memories. Some embodiments of the memory hierarchy 104 may implement die-stacked memory to increase capacity or otherwise take advantage of multiple memories while maintaining a smaller overall footprint. Die-stacked memory may be implemented in a vertical stacking arrangement, using through-silicon via (TSV) or other vertical interconnect technologies, or in a horizontal arrangement, whereby the memory dies are “stacked” horizontally relative to the processor or one another, such that they are connected via an interposer. In the embodiment of FIG. 1, the in-package memories 106, 107 are illustrated as being of the same class (denoted class “I”), and the outside-package memories 108, 109 are illustrated as being of the same class (denoted class “II”). The classification of the memories 106, 107, 108, and 109 as such is outlined in greater detail below.

The processor 102 comprises processor cores 110, 111, and a memory controller 112 having a configuration module 114. While the illustrated embodiment depicts a memory controller 112 implemented at the processor 102, in other embodiments, the memory controller 112 may be implemented elsewhere, for example, at a memory interface of a stacked memory device implementing one or more of the memories 108, 109. The memory controller 112 allocates a unified, flat address space to the memories 106, 107, 108, 109 and retrieves data from the memories 106, 107, 108, 109 in response to a memory address request based on this address space allocation. For example, the memory controller 112 of some embodiments first partitions the address space into address blocks and allocates the address blocks to the memory classes (I, II). Then for each class (I, II), the memory controller 112 partitions the address blocks allocated to the class (I, II) into address subblocks and interleaves the address subblocks among the memories 106, 107, 108, 109 within the class (I, II). Thus, in the illustrated embodiment, the memory controller 112 treats the memories 106, 107, 108, 109 as a single, flat, unified memory address space 116. As a result, the different classes (I, II) of memories are still logically part of the same level of the traditional memory hierarchy, in that they are all part of the same main or system memory, and are therefore all accessible through the same, unified, flat physical memory address space. Additionally, this class-interleaving technique allows the address space to be efficiently allocated among the memories 106, 107, 108, 109, such that data can be requested concurrently from memories within the same class (I, II) and the requested data will return in approximately the same order as requested due to the similar access speeds of the same-class memories, and thus the memory controller 112 can better accommodate the different performance metrics of the different memories 106, 107, 108, 109 while continuing to take advantage of the benefits memory address interleaving. The allocation of address blocks and subblocks to classes and memories can be programmed, hardwired into circuitry, chosen based on a plurality of mappings, controlled by an address table, a combination of these, and the like. In some embodiments, the configuration module 114 may comprise any combination of address tables, registers, fuses, and the like, to facilitate mapping of the memories to the memory address space 116.

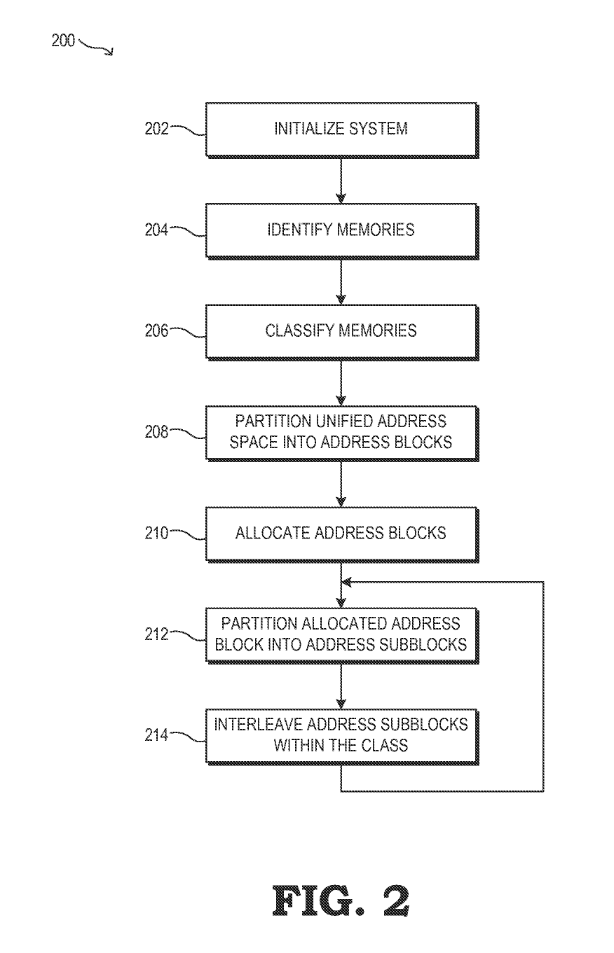

FIG. 2 illustrates an example method 200 for allocating a unified memory address space among memories of a multilevel memory system in accordance with some embodiments of the present disclosure. For ease of reference, the method 200 is described below in the example context of the multilevel memory system 101 of FIG. 1. The method 200 initiates at block 202, whereby the processing system 100 is booted, and the memory controller 112 identifies the unified memory address space 116. For example, in some embodiments, the processing system 100 queries each memory 106, 107, 108, 109 of the unified memory address space 116 during the basic input-output system (BIOS) stage of boot-up to identify characteristics of each memory 106, 107, 108, 109. For such queries, the memories 106, 107, 108, 109 can be configured to respond with their respective memory characteristics useful in classifying the memories, such as capacity, location, level, type, a combination of these, and the like. The unified memory address space 116 of some embodiments may include only a subset of the memories of the plurality of memories in the multilevel memory system 101, while in other embodiments the unified memory address space 116 may include all of the memories in the multilevel memory system 101.

At block 204, the memory controller 112 identifies the memories 106, 107, 108, 109 within the unified memory address space 116, and at block 206 the memory controller 112 classifies each of the memories 106, 107, 108, 109 into its respective memory class (denoted class “I” and “II”) based on its level, type, or both. As such, in some embodiments the memories 106, 107, 108, 109 may be classified such that memories within the same class share one or more of the same level, the same type, and other operational characteristics, such as access time, bandwidth, data transfer rate, and the like. To illustrate, the memories 106, 107 may be classified as class I as they both are at the same level (e.g., in-package) and the memories 108, 109 may be classified as class II as they both are at the same level (e.g., outside-package), or the memories 106, 107 may be classified as class I as they both implement, for example, DRAM architectures whereas the memories 108, 109 may be classified as class II as they both implement, for example, SRAM architectures, and the like.

At block 208, the memory controller 112 partitions the unified memory address space 116 into contiguous address blocks (that is, the addresses within a given address block are contiguous/consecutive), which may differ in size, and at block 210, the memory controller 112 allocates the address blocks of the unified address space among the plurality of memory classes (I, II). The memory controller 112 may employ any of a number of allocations, such as, an even distribution, a random distribution, a distribution based on class characteristics, a combination of these, and the like. In some embodiments, the memory controller 112 may allocate multiple address blocks to at least one of the memory classes (I, II). To illustrate, in one implementation, the memory controller 112 may partition the unified memory address space 116 into two contiguous address blocks, with one address block allocated to class I and the other address block allocated to class II. As another example, the memory controller 112 may partition the unified memory address space 116 into four contiguous address blocks, with the first and third address blocks allocated to class I and the second and fourth address blocks allocated to class II. The size of each block may depend on, for example, the characteristics of the memories of the corresponding class, such as the relative capacity of the memories in each class, the access speed or level of the memories in each class, and the like.

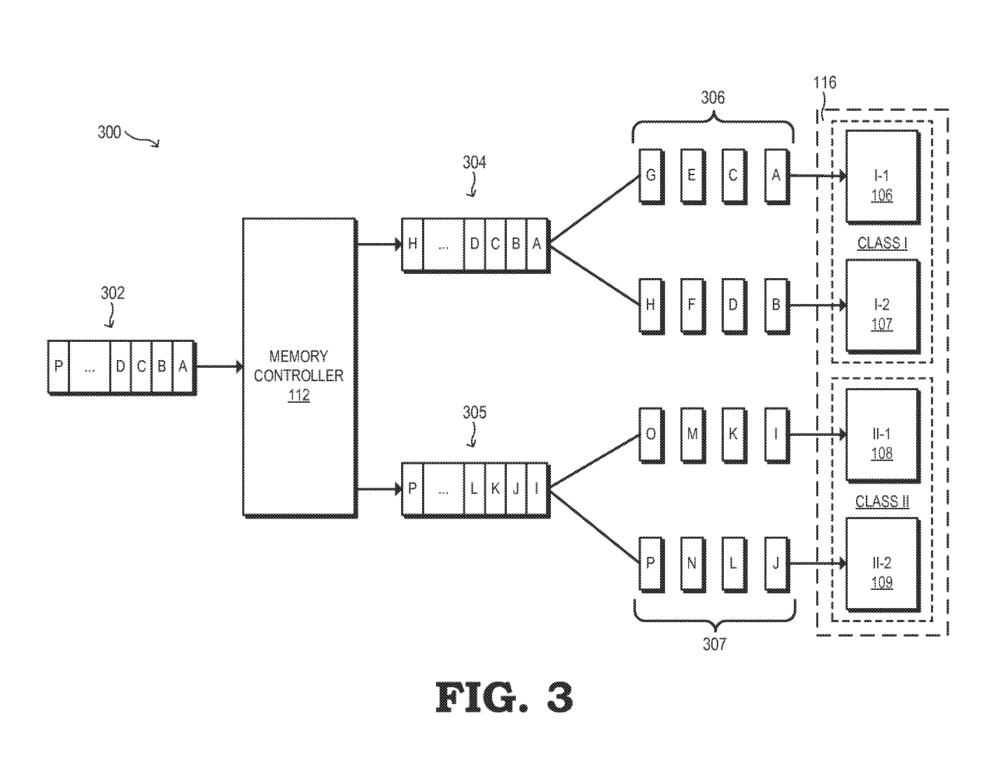

At block 212, the memory controller 112 selects an address block and partitions the selected address blocks into contiguous address subblocks, and at block 214, the memory controller 112 interleaves the contiguous address subblocks among the individual memories associated with the class to which the selected address block had been allocated. The address subblocks represent smaller portions of the address blocks allocated to each memory class and may vary in size or all be of uniform size. In some embodiments, the memory controller 112 may further interleave the address subblocks or a portion of the address subblocks among memory banks within a given memory 106, 107, 108, 109. The address subblocks may be allocated to individual memories based on an even distribution, a random distribution, a distribution based on memory characteristics, a combination of these, and the like. The process of blocks 212 and 214 is repeated for each address block until all address blocks of the unified memory address space 116 have been partitioned and the resulting address subblocks allocated. Aspects of method 200 are further discussed in FIGS. 3-6 below.

FIG. 3 is a diagram illustrating an example memory address space mapping 300 of the multilevel memory system 101 of FIG. 1 in accordance with some embodiments. In the depicted example, the memory controller 112 partitions a unified memory address space 302 (corresponding to, for example, the unified memory address space 116 of FIG. 1) into address blocks 304, 305, and allocates the address blocks 304, 305 to class I and class II, respectively. In the illustrated embodiment, the memory controller 112 has divided the address space 302 comprising address subblocks “A” through “P” evenly into address block 304 comprising the address subblocks “A” through “H” to be mapped to class I, and address block 305 comprising the address subblocks “I” through “P” to be mapped to class II.

The memory controller 112 then partitions the address blocks 304, 305 into sets 306, 307 of address subblocks, respectively, and interleaves the address subblocks of sets 306, 307 among the memories 106, 107, 108, 109 of the class to which the address block 304, 305 has been allocated. For example, in the illustrated embodiment, address block 304, which has been allocated to class I, is partitioned into the set 306 of address subblocks, such that each of “A,” “B,” “C,” “D,” “E,” “F,” “G,” and “H” is a subblock of the address block 304. The set 306 of address subblocks are then interleaved between the memories 106, 107 of class I, such that address subblock “A” is allocated to memory 106, address subblock “B” is allocated to memory 107, address subblock “C” is allocated to memory 106, and so forth, resulting in the allocation of address subblocks “A,” “C,” “E,” and “G” of set 306 to memory 106 and the allocation of address subblocks “B,” “D,” “F,” and “H” of set 306 to memory 107. Similarly, address block 305, which has been allocated to class II, is partitioned into the set 307 of address subblocks, such that each of “I,” “J,” “K,” “L,” “M,” “N,” “0,” and “P” is an address subblock of the address block 305. Address subblocks of the set 307 are then interleaved between the memories 108, 109 of class II, such that address subblock “I” is allocated to memory 108, address subblock “J” is allocated to memory 109, address subblock “K” is allocated to memory 108, and so forth, resulting in the allocation of address subblocks “I,” “K,” “M,” and “O” of set 307 to memory 108 and the allocation of address subblocks “J,” “L,” “N,” and “P” of set 307 to memory 109. The address subblocks may be of any size and need not be evenly allocated among the memories 106, 107, 108, 109. Some embodiments recognize that for purposes of product positioning, recovering parts with manufacturing defects, or otherwise, there may be instances when it is preferred or necessary that some of the memory of the memory address space is not utilized, and therefore populate only a subset of the memory address space. For example, one of the memories 107 may not be populated, and as a result, all of the address subblocks of set 306 are interleaved or otherwise allocated among the remaining memories 106 of the same class.

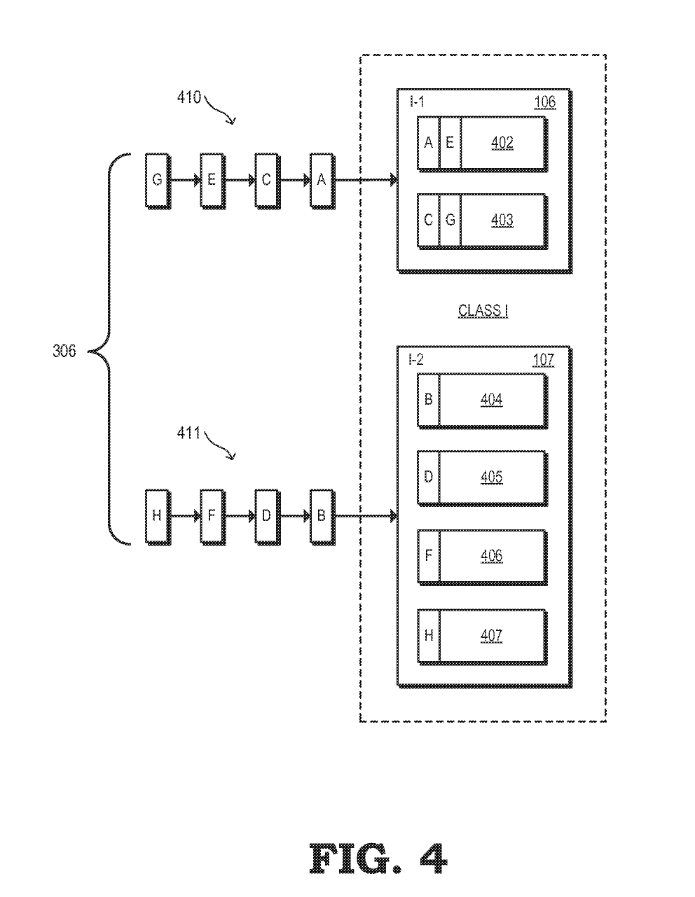

FIG. 4 is a diagram illustrating an example bank-interleaved memory address space mapping 400 for a multilevel memory system employing a multiple-bank memory (e.g., a DRAM memory) in accordance with some embodiments. In some implementations, some or all of the memories 106, 107, 108, 109 of the multilevel memory system 101 (FIG. 1) may implement a memory architecture that organizes the memory into multiple memory banks. To illustrate, the memories 106 and 107 may be architected to include banks 402 and 403 at the memory 106 and banks 404, 404, 406, 407 at the memory 107. While the illustrated memories 106, 107 are depicted as being divided into two and four memory banks 402, 403, 404, 405, 406, 407, respectively, other embodiments may employ any number of memory banks within any of the memories of the memory address space 116 (FIG. 1). The depicted example depicts the address subblocks of set 306 after the memory controller 112 (FIG. 3) has interleaved the address subblocks among the memories 106, 107 of class I, such that subblock subsets 410 and 411 are allocated to memories 106 and 107, respectively. The memory controller 112 then interleaves the address subblock subsets 410, 411 allocated to a given memory 106, 107 among the memory banks 402, 403, 404, 405, 406, 407 of the given memory 106, 107. For example, as illustrated, subblock subset 410 is interleaved among the two memory banks 402, 403 of memory 106 such that address subblocks “A” and “E” are allocated to bank 402 and address subblocks “C” and “G” are allocated to bank 403, and subblock subset 411 is interleaved among the four memory banks 404, 405, 406, 407 of memory 107 such that address subblocks “B”, “D”, “F”, and “H” are allocated to memory banks 404, 405, 406, and 407, respectively.

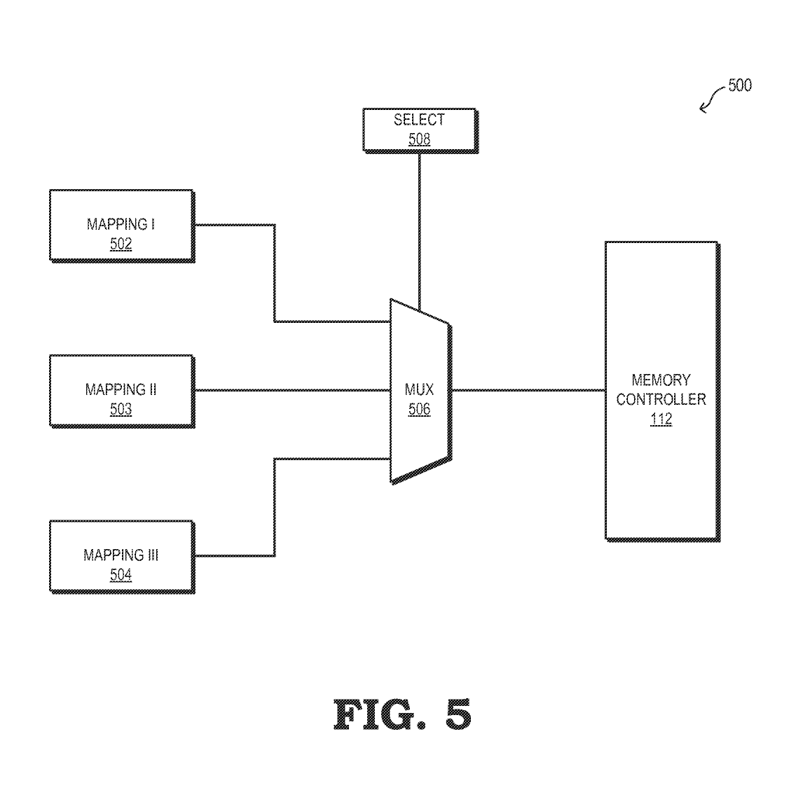

FIG. 5 is a block diagram of a mapping configuration system 500 employed in the processing system 100 to selectively configure the memory address space mapping of the multilevel memory system 101 of FIG. 1 in accordance with some embodiments. The mapping configuration system 500 represents, for example, one implementation of the mapping configuration module 114 of FIG. 1 The technique for mapping or allocating memory address space to the available memories may be configurable during manufacturing, at boot-time, and during execution by implementing fuses or control registers that can define the mappings. In one embodiment, the mapping configuration system 500 employs multiplexer 506 that receives multiple hardcoded or reconfigurable mappings 502, 503, 504 that are either hardwired into the circuitry of the processor or implemented as a table or other data structure that can be reconfigured via, for example, a basic input output system (BIOS), operating system, or application. Each of the mappings 502, 503, 504 represents a different allocation of the unified memory address space 116 among the classes, within each class, or a combination thereof. To illustrate, mapping 502 may provide for a division of the address space into two address blocks, and an equal allocation of the address subblocks of each address block among the memories of the corresponding class, whereas mapping 503 may provide for a division of the address space into four address blocks, and an unequal allocation of the address subblocks of each address block among the memories of the corresponding class. In response to a selection 508, the multiplexer 506 provides the selected mapping to the memory controller 112, such that the memory controller 112 can then allocate the address space to the memories according to the selected mapping 502, 503, 504.

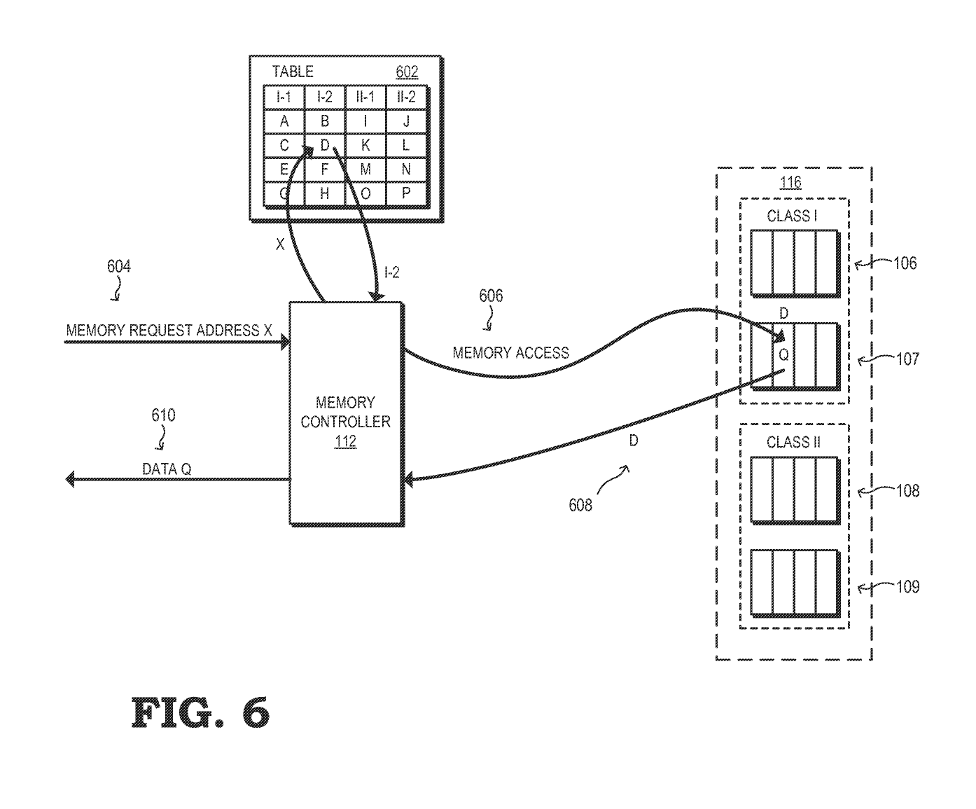

FIG. 6 is a diagram illustrating an example operation 600 of the memory controller 112 utilizing a memory address table 602 to locate data in response to a memory address request 604 in the unified memory address space 116 in accordance with some embodiments. The address table 602 in some embodiments may be implemented in the form of a collection of memory storage elements (e.g. SRAM, registers, etc.). The address table 602 may be populated based on one or more hardwired mappings 502, 503, 504 (FIG. 5), software, user input, the allocation of the unified memory address space by the memory controller 112, a combination of these, and the like. Alternatively, a mapping 502, 503, 504 may comprise the address table 602, such that the mapping allocates memory to the memory address space based on the table 602. Additionally, some embodiments may employ multiple tables 602 for efficiency purposes or otherwise.

In the illustrated operation the memory controller 112 receives the memory request 604 for address “X” from the processor, and accesses the address table 602 to determine which of memories 106, 107, 108, 109 has been allocated address “X.” In the illustrated example, address “X” falls within the range represented by address subblock “D” and accordingly has been mapped to the second memory 107 of class I. With this information the memory controller 112 is able to perform a memory access 606, in which it locates the memory address “X” within subblock “D” of memory 107 and retrieves subblock “D” 608 stored at memory address “X.” The memory controller 112 then sends the data value “Q” 610 located at memory address “X” within the subblock “D” 608 to the processor 102 in response to the memory request 604.

In some embodiments, the apparatus and techniques described above are implemented in a system comprising one or more integrated circuit (IC) devices (also referred to as integrated circuit packages or microchips), such as the multilevel memory system described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

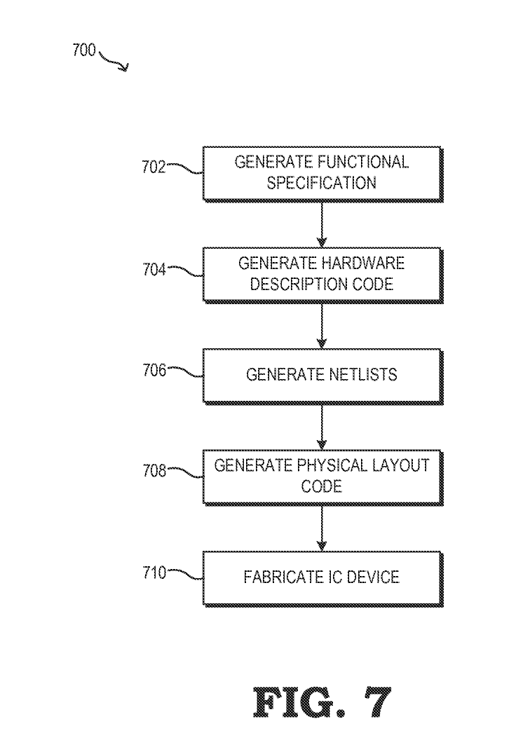

FIG. 7 is a flow diagram illustrating an example method 700 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 702 a functional specification for the IC device is generated. The functional specification (often referred to as a micro architecture specification (MAS)) may be represented by any of a variety of programming languages or modeling languages, including C, C++, SystemC, Simulink, or MATLAB.

At block 704, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 706 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 708, one or more EDA tools use the netlists produced at block 706 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 710, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system comprising:
a memory controller coupleable to a plurality of memories, the memory controller to:
classify each memory of the plurality of memories in accordance with a plurality of memory classes;
allocate address blocks of a unified memory address space among the plurality of memory classes; and
for each memory class of the plurality of memory classes, interleave address subblocks of each address block allocated to the memory class among the memories of the memory class.

2. The system of claim 1, wherein the unified memory address space comprises a single contiguous address space of consecutive address values.

3. The system of claim 1, wherein:
at least a first memory class of the plurality of memory classes exclusively comprises memories of a first memory type; and
at least a second memory class of the plurality of memory classes exclusively comprises memories of a second memory type different than the first memory type.

4. The system of claim 1, wherein:
at least a first memory class of the plurality of memory classes exclusively comprises memories at a first memory level; and
at least a second memory class of the plurality of memory classes exclusively comprises memories at a second memory level different than the first memory level.

5. The system of claim 1, wherein:
at least a first memory class of the plurality of memory classes exclusively comprises in-package memories; and
at least a second memory class of the plurality of memory classes exclusively comprises outside-package memories.

6. The system of claim 1, wherein each memory class of the plurality of memory classes comprises memories of a corresponding memory type and a corresponding memory level.

7. The system of claim 1, further comprising:
the plurality of memories, wherein each memory is configured to provide an indicator of one or more characteristics of the memory responsive to a query from the memory controller during a boot-up process at the system.

8. The system of claim 1, wherein the memory controller is further to:
maintain a map address table to specify which address subblocks map to which memory.

9. The system of claim 1, wherein the memory controller is to allocate the address blocks and interleave the address subblocks based on a programmable memory address space mapping.

10. The system of claim 1, wherein:
at least one memory of the plurality of memories comprises a set of memory banks; and
the memory controller is to interleave the address subblocks allocated to the at least one memory between each bank of the set of banks of the at least one memory.

11. A method comprising:
classifying each memory of a plurality of memories of a processing system in accordance with a plurality of memory classes;
allocating address blocks of a unified memory address space among the plurality of memory classes; and
for each memory class of the plurality of memory classes, interleaving address subblocks of each address block allocated to the memory class among the memories of the memory class.

12. The method of claim 11, wherein the unified memory address space comprises a single contiguous address space of consecutive address values.

13. The method of claim 11, wherein allocating the address blocks further comprises:
allocating the address blocks among the plurality of memory classes based on characteristics of the memory classes.

14. The method of claim 11, wherein:
at least a first memory class of the plurality of memory classes exclusively comprises memories of a first memory type; and
at least a second memory class of the plurality of memory classes exclusively comprises memories of a second memory type different than the first memory type.

15. The method of claim 11, wherein:
at least a first memory class of the plurality of memory classes exclusively comprises memories at a first memory level; and
at least a second memory class of the plurality of memory classes exclusively comprises memories at a second memory level different than the first memory level.

16. The method of claim 11, wherein interleaving address subblocks of each address block allocated to the memory class among the memories of the memory class comprises interleaving address subblocks allocated to a memory by interleaving the address blocks among a plurality of memory banks of the memory.

17. A non-transitory computer readable storage medium embodying a set of executable instructions, the set of executable instructions to manipulate a computer system to perform a portion of a process to fabricate at least part of a processor, the processor comprising:
a memory controller to:
classify each memory of a plurality of memories coupleable with the processor in accordance with a plurality of memory classes;
allocate address blocks of a unified memory address space among the plurality of memory classes; and
for each memory class of the plurality of memory classes, interleave address subblocks of each address block allocated to the memory class among the memories assigned to the memory class.

18. The computer readable storage medium of claim 17, wherein the unified memory address space comprises a single contiguous address space of consecutive address values.

19. The computer readable storage medium of claim 17, wherein:
at least a first memory class of the plurality of memory classes exclusively comprises memories of a first memory type; and
at least a second memory class of the plurality of memory classes exclusively comprises memories of a second memory type different than the first memory type.

20. The computer readable storage medium of claim 17, wherein:
at least a first memory class of the plurality of memory classes exclusively comprises memories at a first memory level; and
at least a second memory class of the plurality of memory classes exclusively comprises memories at a second memory level different than the first memory level.
